(19) United States
(12) Patent Application Publication
(10) Pub. No.: US 2004/0243532 A1
(43) Pub. Date: Dec. 2, 2004

(54) Method and apparatus/software to assist persons in complex cause-and-effect reasoning

(75) Inventor: Donald Steward, Napa, CA (US)

Correspondence Address: DONALD V. STEWARD, 1000 BANBURY COURT, NAPA, CA, 94558-4354, US

(73) Assignee: Problematics LLC, Napa, CA (US)

(21) Appl. No.: 10/264,437

(22) Filed: Oct. 3, 2002

(51) Int. Cl. G06N 7/08; G06N 7/00; G06F 17/00; G06N 5/02; G06F 17/10; G06F 7/60

(52) U.S. Cl. 706/57; 706/46; 703/2

(57) ABSTRACT

A method has been developed for generating, refining and determining the consequences of complex systems of multiple cause and effect relationships. The novel method is applicable to biological systems as well as man-made systems, as it is based on the collecting and using observed behaviors as well as previous understood mechanism or relationships. The method is particularly useful in multi-variable system with significant interactions among sub-components, especially when there is limited expertise or complete understanding of all the components and their respective relationships interactions. In these cases the method provides guidance for future experiments that develop further expertise. The method has particular power and benefit as it provides for a distinction and comparison of the merits of conducting further experiments based on defined criteria. For example alternative solutions or experiments can be suggested and distinguished on the basis of cost, delay or a negative or detrimental outcome, based on prior experience and knowledge of interactions, in contrast to those that provide additional insight or solve the problem with a lower risk of negative implications.

### CROSS REFERENCE TO RELATED APPLICATIONS

None

### Background of Invention

The present invention relates to a method of developing, refining and using expert systems, to solve and diagnose problems represented by multivariable dependent systems; including those implemented on a computer readable medium having computer executable instructions.

Prior methods of developing and using so-called “expert systems” for the solving or diagnosis of problems required an expert to develop a logical structure that would generate a series of queries wherein the answers to each query would select additional queries, until the software develops the conclusions similar to those that could be reached by analogy to how an expert would reach his or her conclusions.

Using prior methods of developing and using so-called “expert systems” one tries to guess the controllable and assumed causes of specified observable events based on the judgments of an existing expert or experts without recourse to understanding the unobservable primitive mechanisms that explain the behavior.

Users of prior “expert systems’ may not know the assumptions used by the expert in formulating the model and may be inclined to use the model under circumstances where those assumptions are not satisfied.

Because prior methods of developing and using so-called “expert system” do not rely on the underlying mechanisms of primitive cause and effect relations, they are limited in the questions that can be asked of them to those anticipated by the expert.

Because prior methods of developing and using so-called “expert system” do not rely on the underlying mechanisms of primitive cause and effect relations, they cannot be easily modified with new knowledge introduced by anyone other than the original expert.

Conventional expert systems have found many practical applications in customer service and to provide professional training and expertise to general practitioners in various fields. However, they are primarily of limited applicability, being limited to well understood and characterized systems where the expertise has been generated by significant experimentation or observations or experience acquired over time. Furthermore, to develop an expert system requires an expert who can construct the structure of the query logic in a manner where each query predictably leads to the ultimate result.

However, in reality there are indeed few experts in relation to all the existing complex systems for which one would like to have diagnostic methods, be the systems naturally occurring or man-made or designed

Accordingly, it is an object of the invention to provide a method of generating, testing, and refining proposed cause and effect systems that provide guidance into diagnostic steps more likely to be fruitful and unlikely to have a negative outcome that is either temporarily or permanently detrimental to a real system.

It is also an object to the invention to provide a method of expanding expert systems based on the outcome of the diagnostic steps taken.

Yet another object of the invention is to provide a method-of determining whether a potential solution has been identified based on the accumulated experience of multiple diagnostic steps.

A further object of the invention is to provide methods and data structures that permit simple natural language queries for both constructing and using expert systems.

An objective of using a cause and effect model developed by means of this invention is to make it possible for the user to see and possibly change the assumptions.

Another objective of using a cause and effect model developed by means of this invention is to make it possible to see the cause and effect logic that has led to the conclusions the model has reached and change that logic if appropriate.

### SUMMARY OF INVENTION

The present invention provides methods of developing, refining and using cause and effect models to diagnose and solve problems represented by systems of simultaneous multivariable Boolean equations involving AND's and OR's representing primitive cause and effect relations that define whether certain events exist or do not exist including those implemented on a computer readable medium having computer executable instructions.

In the present invention, the first object is achieved by constructing a hypothetical system of simultaneous Boolean equations by defining a set of events to be considered, stating which of those events are primary, that is within the control of the user or can be assumed by the user, which of those events are secondary, that is they depend on the existence of primary and/or other secondary events, and which of these secondary events are observable or intermediate (hidden) and the relationship between each event and every other pertinent event expressed as a primitive Boolean expression.

By the Boolean expressions one defines the truth or falsity of the existence of each secondary event as a Boolean expression of other events (Preferred implementation: Disjunctive form, i.e., OR's between sets of AND's) to create a system of simultaneous Boolean equations.

Another objective is achieved by solving this system of simultaneous Boolean equations so as to express the truth of each secondary event as a Boolean expression of the truth of primary events.

Another objective is achieved by setting the existence of a certain subset of primary events as as true and determining as a consequence what secondary events then exist.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 shows a legend and schematic representing Example II.

FIG. 2 shows one possible structure shown as applied to Example I and to Example II.

FIG. 3 shows an alternative user interface using a matrix structure as applied to example II.

FIG. 4 shows the Boolean rules and meta-rules used in the solution of the Boolean equations.

FIG. 5 shows the Boolean equations corresponding to Example II.

FIG. 6 shows the calculations used to solve the equations in FIG. 5.

FIG. 7 shows the outline representation for the input to Example I.

FIG. 8 shows a embodiment for implementing a data structure useful in the computer implementation of the user interface using an outline.

### DETAILED DESCRIPTION

Definitions

The cause and effects models to be constructed and solved are constructed by specifying events and relationships between events. Events are situations that may or may not exist. The same events can at various times act either as causes or effects. Thus the relationship between various events is that the occurrence or existence of one event can contribute to causing of another event to exist.

An event is considered to exist or be present when the Boolean conditions for it to be true are satisfied. Otherwise it is assumed to not exist or be absent. (Note that an event does not have to be False for it to not exist, just that it not be true.) If an event is neither True nor False, it is irrelevant.

An event is non-true if it is either false or its truth or falsity is not defined thus making it irrelevant.

The events can be either primary or secondary. Primary events are any events that can be set as true or false or not set by the user. Primary events may be used to describe controllable actions that can be taken or prescribed, or assumptions that are made.

Primary events are those subsets of the events that the user can select whether they exist or do not exist or whether they are assumed to exist or not exist.

The user at his or her discretion may set any, but not necessarily all, of primary events to be True or False or irrelevant if not set to either true nor false.

Primary events are designated controllable or controls if they are under the control of the user to take or not take, i.e.; they can become a prescription of what one can do to cause or prevent an event, or assumable or assumes if the user can assume or not assume their existence at his or her discretion.

A subset of primaries can be set by the User to exist by setting their values to true.

Assumed events can be used to assume the existence or not existence of external causes that are not otherwise part of the current model.

Secondary events are all those events that may be caused by primary events or by other secondary events. Secondary events may be intermediate/hidden or observable.

Observable events are those that can be directly observed or observed after a test as to whether they exist.

A Boolean expression or combination in disjunctive canonical form consists of Terms that imply that all the effects within a Term must be present or not present as specified to cause the term to be satisfied. ORs are placed between Terms to imply that when any one of the terms is satisfied that the expression is satisfied.

A Term is a subset of events joined by ANDs such that they cause an event to exist (true) if each and every one of those events in the term either exists (true) or is non-true as specified. An event is satisfied if the value of at least one of its terms is true. A Boolean expression can be used to form a Boolean equation to say that when the expression is satisfied that a specified event exists (true).

A term can have either of two types of receptors. An existence receptor requires the existence of another event in order for the term to be satisfied. A non-existence receptor requires the non-existence (i.e., the existence be non-true) of another event in order for the term to be satisfied.

A primitive cause and effect relation is the expression of whether a given event exists (true) according to whether a Boolean expression of AND's and OR's results in the value true (exists).

An option is the satisfaction of the conditions of any term. ORs between terms imply that there is more than one option that will satisfy the existence of an event.

A cause and effect model is made up of a set of primitive cause and effect relations.

Thus the events and their causal interrelationships are represented/modeled by systems of simultaneous Boolean equations. The Boolean equations are solved to trace secondary events back to the primary events that cause them. A model may become a template that can be used by others in developing their own models or applied by others in making diagnoses and receiving advice for how to set primary events to obtain wanted consequences.

A mechanism is a set of paths through the satisfied events in a cause and effect model that lead to a term that explains how a cause or combination of causes generates a term that would produce an effect. A mechanism may be ruled out in developing the model if it produces effects that don't conform to reality.

A recursive set of equations are those subset of equations for which there exists some order in which they than can be solved such that each equation can be solved for its dependent variable having all its independent variables previously solved for. Non-recursive equations are those subsets of equations that cannot be solved recursively.

One develops a model by building or constructing it from primitive cause and effect relations. Refining a model is to make improvements in the hypotheses represented in the cause and effect model so that it better predicts what effects do or do not exist.

In an embodiment the method may be implemented on a general purpose computer using software to determine primary causes of each secondary event by solving the Boolean equations to express the existence or non-existence of each secondary event as a Boolean expression of the pertinent subset of the primary events.

An additional embodiment includes methods of use wherein one provides a setting of controllable and assumable events that will cause a given secondary event to exist or will prevent a given secondary event from existing.

Embodiments

In one embodiment the Boolean equations are solved using Boolean substitution, Boolean multiplication of expressions, and the axioms of Boolean algebra and meta-rules to express all secondary events as a function of primary events.

Another embodiment of this invention uses the software of this invention implemented on a computer readable medium having computer executable instructions to solve these simultaneous Boolean equations so as to express whether certain events exist or do not exist in terms of the existence or non-existence of certain primary events that a user might later wish to specify whether they exist.

Another implementation of this invention uses the software of this invention implemented on a computer readable medium having computer executable instructions to create and test hypotheses of how a system made up of individual primitive cause and effect relations would behave as a whole.

Another implementation of this invention uses the software of this invention implemented on a computer readable medium having computer executable instructions to use that same system of Boolean equations to determine the existence or non-existence of secondary effects as various combinations of primary events that may be specified to exist or specified as assumed to exist by the user.

In another embodiment theaxioms of Boolean algebra and meta-rules are used to eliminate any false or redundant expressions and sub-expressions that need not appear in any further calculations, thus saving unnecessary calculations.

Boolean algebra is used to express the results in various ways most convenient to the user, such as but not limited to disjunctive or conjunctive canonical form.

In yet another embodiment of the invention, the Boolean expression may be augmented by assigning probabilities to each of the primary effects that are set by the user, and assigning to each term of each primitive cause and effect relation the probability that the joint presence or absence of the causes specified by that term would cause the target event to exist. Thus by assuming that the only correlation between causes is a consequence of having common ancestors, the probability of the existence of each event can be computed by multiplying the probabilities of each cause of each term to reach the probability of all the causes for that term existing and thus the term being satisfied, and multiplying this by the probability that given the satisfaction of the term that the target event will be caused to exist.

In another embodiment once the secondary events are expressed in terms of the primary events and the paths thus established numerical calculations can be done on the events in the path such as but not limited to the probabilities of the events occurring or the magnitude of the effects. For example after tracing to identify paths and mechanisms various numerical calculations can be made on the existing events, or factors associated with the outcome or choice of events, in those paths.

In another embodiment once the secondary events are expressed in terms of the primary events one can ask for the negation of a secondary effect.

In another embodiment once the secondary events are expressed in terms of the primary events one can select any term of any secondary effect or the negation of such an effect to have that term become the setting of the primaries so as to determine all the consequences of selecting that term as an option.

The existence of secondary events may be true or non-true depending on the existence of primary or other secondary events. The system of simultaneous Boolean equations is solved to express the truth of the existence of each secondary event in terms of the truth of the primary events or Boolean expressions for the truth of primary events. Then given any secondary event, it is shown what Boolean expression for the existence or absence of primary events will cause that secondary event to be true or to be non-true.

Uses of the Invention

Software enabling the aforementioned embodiment can be used in either of two modes. Mode One would be utilized to develop the model by a Developer who would have access to all events whether primary or secondary and to all capabilities of the software. Mode Two would be utilized by a User who would have access to the primaries and the observable secondaries to be able to determine the primary causes of any specified observable secondary events and to determine the effects/consequences of setting as true certain applicable primary events.

The method is useful where one party or parties develop the model/system allowing other parties to apply the model/system for such purposes as making diagnoses and reviewing advice as to how to cause or prevent certain events.

The method is also useful where one party is both the developer and user as that party tries to understand the working of a system of cause and effects. .

A developer may use this software to develop cause and effect hypotheses, determine the consequences of these hypotheses, determine whether these consequences fit reality, trace the mechanism that produces consequences that do not fit reality, and change the hypotheses as appropriate.

The novel method is applicable to understanding biological or physical systems as well as man-made systems as it is based on collecting and using observed or hypothesized behaviors based on cause and effect relationships. The behaviors predicted by the model can be compared with reality and the model refined to better predict reality.

The method is particularly useful where there is no established expertise or complete understanding of all the components and their respective interactions, as the method provides guidance for consideration of observations, future experiments and hypothesizes, thus developing new expertise.

The above and other objects, effects, features, and advantages of the present invention will become more apparent from the following description of the embodiments thereof taken in conjunction with the accompanying drawings.

By means of this invention one can build a cause and effect model that can be used either by the model builder or someone else to diagnose and determine the primary causes of certain secondary events and show the Boolean combination of primary events that would result in the secondary events being either caused or prevented.

By means of this invention one can build cause and effect models knowing only certain primitive cause and effect relations without the availability of established experts who already have experience in the matters predicted by the model.

By means of this invention one can determine the effects of certain causes so that while building the model one can rule out certain cause and effect mechanisms on the ground that they do not properly account for what is observed in reality.

By means of this invention one can determine what options there are for actions in the form of setting primary effects that one might declare to exist to cause or prevent certain specified events.

By means of this invention one can test various options of actions that might be taken to see what effects they would have and thus possibly rule out certain options that might have effects that are not to be tolerated.

The diagnosis and/or resolution of an undesirable situation in a complex system requires the consideration of the effects of multiple mechanisms. As there may be little observable information, or it may not be exclusively linked to the outcome, it may be necessary to experiment, that is modifying the condition or state of identifiable primary events to determine if they influence any of the observable events.

In one embodiment the model may consist of a system of simultaneous Boolean equations expressing the truth or falsity of the existence of certain events in terms of Boolean expressions involving And's and Or's of the truth or non-truth of the existence of certain other events.

In another embodiment the causal relationship can be a simple logical relationship, that is “if (condition A), then (result B). Alternatively, the relationship can be expressed in terms of Boolean relationships involving AND's and OR's to establish whether the existence of one event affects whether another event exists.

The existence of secondary events may be true or non-true depending on the existence of primary or other secondary events. The system of simultaneous Boolean equations is solved to express the truth of the existence of each secondary event in terms of the truth of the primary events or Boolean expressions for the truth of primary events. Then given any secondary event, it is shown what Boolean expression for the existence or absence of primary events will cause that secondary event to be true or to be non-true.

The inventive method is applicable to the optimization of physical storage and shipping space in that the allocation of a dimensioned box to a fixed location is a controllable or primary event that effects secondary events, the remaining space, as the initial placement of a first dimensioned box prevents the location of other boxes in the same location, thus limiting them to others.

Additionally, the inventive methods are applicable to designing drugs/chemicals wherein the receptor organ response can be modeled by a cause & effect relationship to indicate what combinations of molecules will be received and what won't, for example the primary and secondary events being defined by the chemicals that inhibit the binding of other chemicals.

Discussion of Method through the Use of Figures

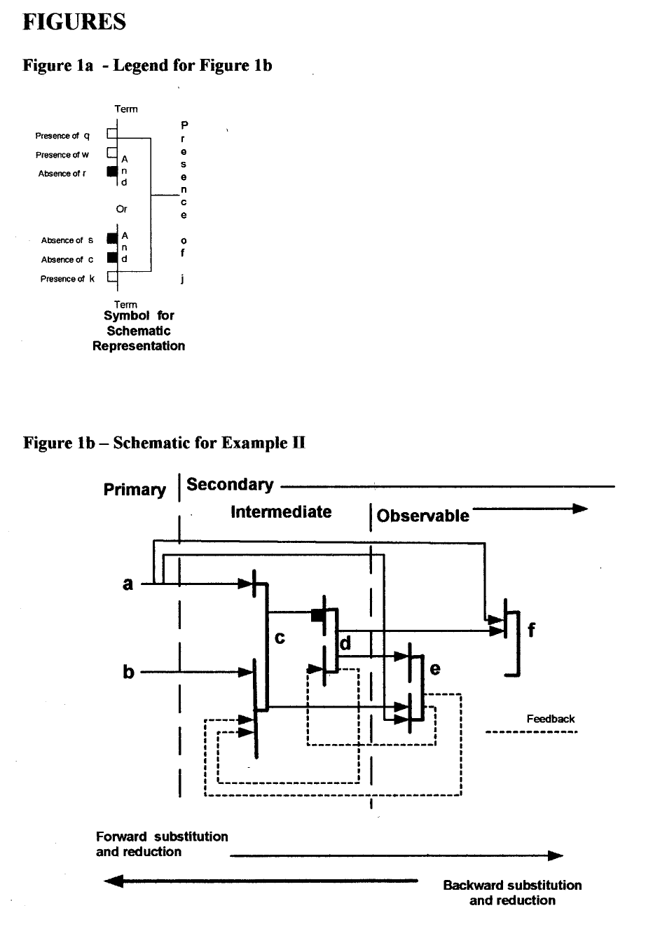

Thus one aspect of the invention is the method and its software implementation on a general purpose computing platform so that one can develop and apply a cause and effect model. Such a model is illustrated schematically in FIG. 1.

FIG. 1 illustrates a cause and effect schematic diagram showing the relationship between primary events, intermediate secondary events and observable secondary events. FIG. 1a presents a legend for the schematic in FIG. 1b. Bars are used to represent terms and are further connected to represent the OR's between terms to produce the existence of the target event. Lines show the connections from events to the terms whose existence they contribute to. If the line terminates at the term bar with an existence receptor shown as an arrow, the existence of the event at the tail of the arrow is required to satisfy the term. If the line terminates at the term bar with a non-existence receptor shown as a small black box, the non-existence of the event at the tail is required to satisfy the term. The dotted lines show feedbacks to earlier effects that are used to represent non-recursive effects. This figure applies to Example II.

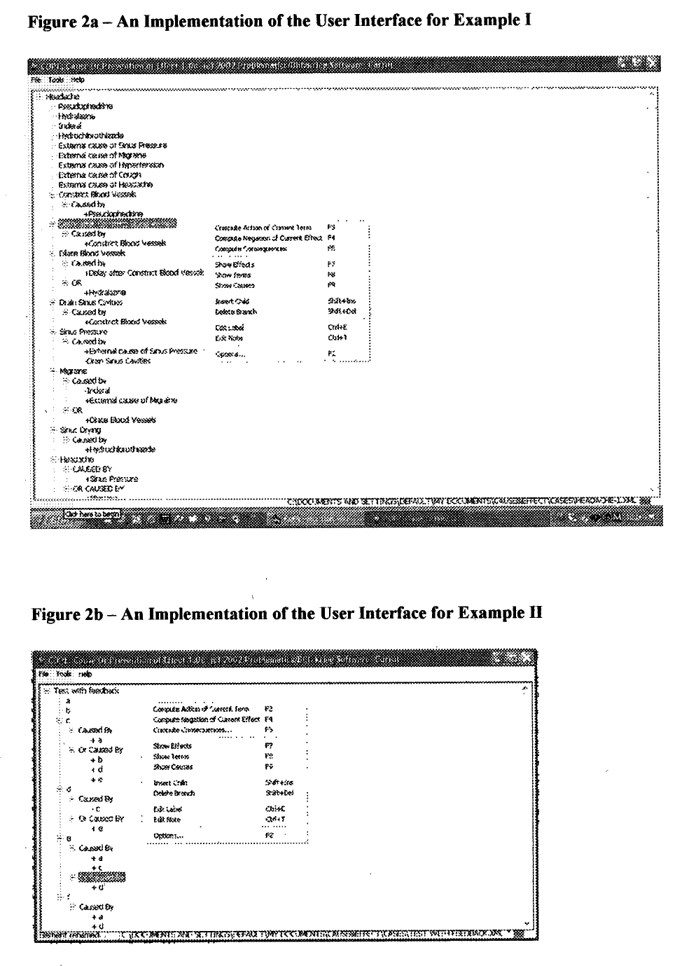

FIG. 2 is a user interface for providing initial inputs to define the cause and effect model. FIG. 2a applies to Example I. FIG. 2b applies to Example II. The input is described as an outline with the events at one level, the terms for that event at a lower level, and the causes making up the term shown at a still lower level. A pop-up menu displays the available options for manipulating the outline and the software program. At the top the outline begins with the problem name. At the next level are the effects, below the effects the terms shown with “caused by” and ‘Or caused by”, and below these the causes that make up the term, as illustrated in FIG. 7.

In one embodiment of the invention the model is generated using the graphic user interface illustrated in FIG. 2. The model is entered as an outline using standard outlining instructions to show each effect at one level, each term of that effect at a lower level, and each cause in that term and whether that cause is to be true or non-true to satisfy the term in a level below the term. As each cause is entered a designation is added to indicate whether that event should exist or not exist to satisfy the term.

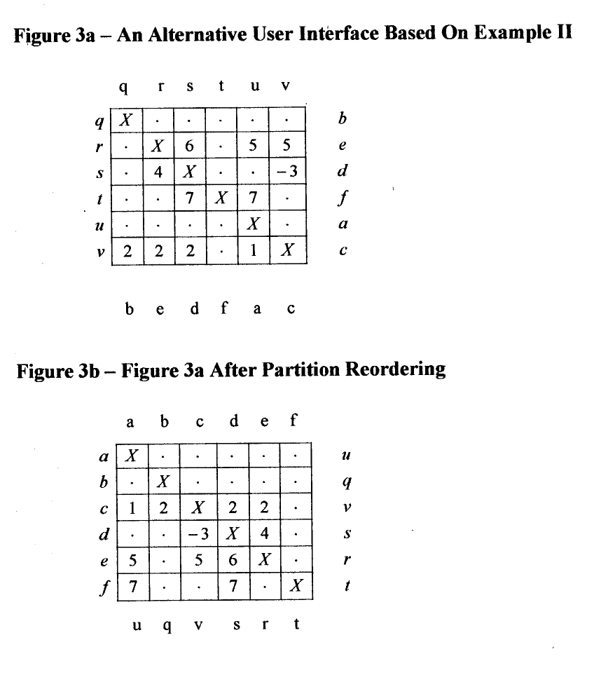

FIG. 3 is an alternative type of user interface wherein matrix cells represent the Boolean relationships that make up the model. It applies to Example II. All primary and secondary events are listed both as rows representing the events in their capacity as effects and as columns representing the events in their capacity as causes such that the placement of a non-blank symbol in a cell of the matrix represents that the column of that cell is in some way a cause of the row of that cell. Cells across a row containing the same symbol indicate that all of the causes with that same symbol represent a set of causes that are ANDed together so that all the conditions of these causes must be satisfied for the term to be satisfied. The required conditions of these causes are shown in one implementation by adding a plus or absence of a minus to the symbol if the cause must exist to satisfy the term and adding a minus to the symbol of causes which must not exist to satisfy the term. X's are used just to fill the diagonal. FIG. 3a shows a cause and effect model. FIG. 3b shows the same model where the rows and columns have been reordered identically so that all the off diagonal non-blank cells appear either below the diagonal or within the smallest possible square blocks on the diagonal. The letters to the right and below each matrix show the order of the rows and columns as they occur in the other matrix. The blocks represent subsets of the equations and their variables that are non-recursive and must be solved jointly by a forward substitution and reduction followed by a backward substitution and reduction. Then the set of equations in each block can be solved in recursive sequence. This ordering is useful for interpreting the model as all cause and effect cycles are contained within the blocks. Such reordering is also pertinent whether or not the model is represented to the user as a matrix.

In an embodiment of a graphical user interface to be used to represent the model illustrated in FIG. 3 the Boolean relationship is expressed or entered directly into the cells of a matrix. One would first enter the number of events to occur in the matrix/model. A blank matrix of that size would be displayed preferably with visual indicia of the diagonal. The columns would represent the events interpreted as the causes. The rows would represent the same events interpreted as effects. Symbols would be entered into the cells as marks where a cause relates to an effect. A term is made up of the And's of all the causes shown with the same symbol as a mark with some other indication as to whether the term is satisfied by the truth or non-truth of the existence of the cause. Where more than one term in an effect may have a common cause, one can cycle through a display showing just one term at a time. For example, Boolean expressions of causes and effects would be indicated by all the same numbers or symbols in a row being joined into a common term by ANDs, then the terms with different numbers or symbols would be ORed.

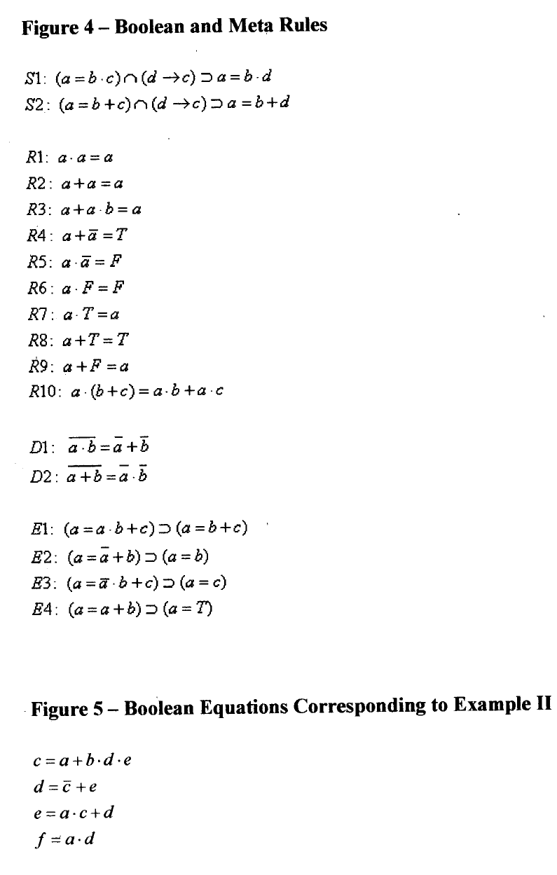

FIG. 4 lists the rules that are used in the calculations. The symbols in the rules are interpreted as follows:

a·b means a AND b

a+b means a OR b

T means True

F neans False

\overline{a} means the non-truth of a

The Meta-symbols used to operate on Boolean rules are interpreted as follows.

(Boolean)∩(b→a) means b replaces a in the Boolean ⊃ means implies

Rules S1 and S2 express how substitution is done. Rules R1 through R10 and Rules D1 and D2 express rules of equivalence. Specifically D1 and D2 express De Morgan's rules of negation. Rules E1 through E4 express additional meta-rules used to eliminate variables in expressions.

FIG. 5 shows the model of Example II as expressed by these rules.

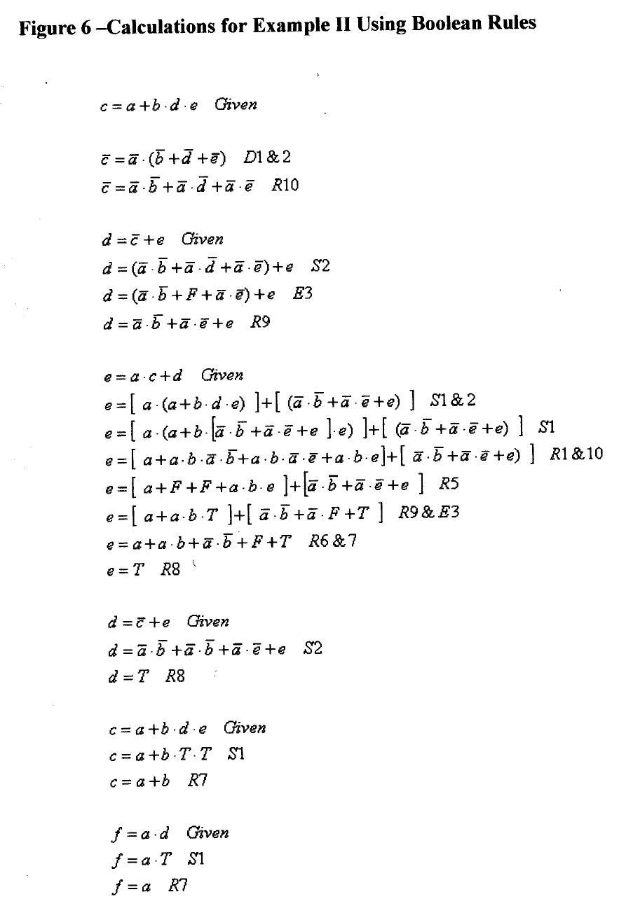

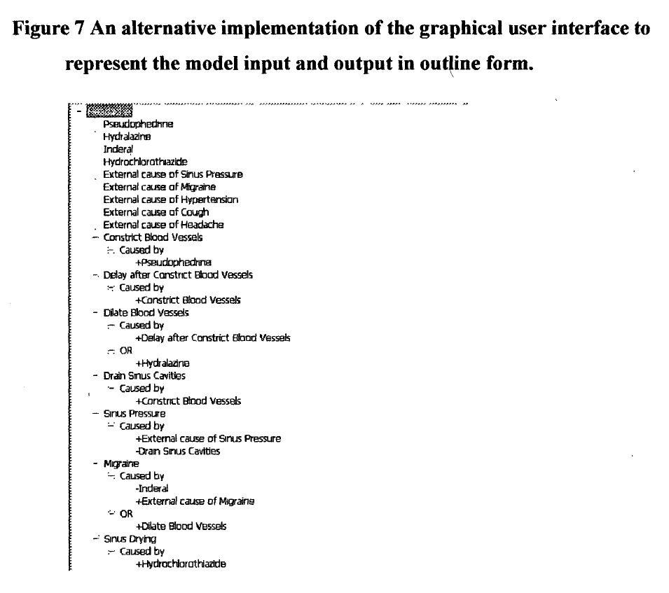

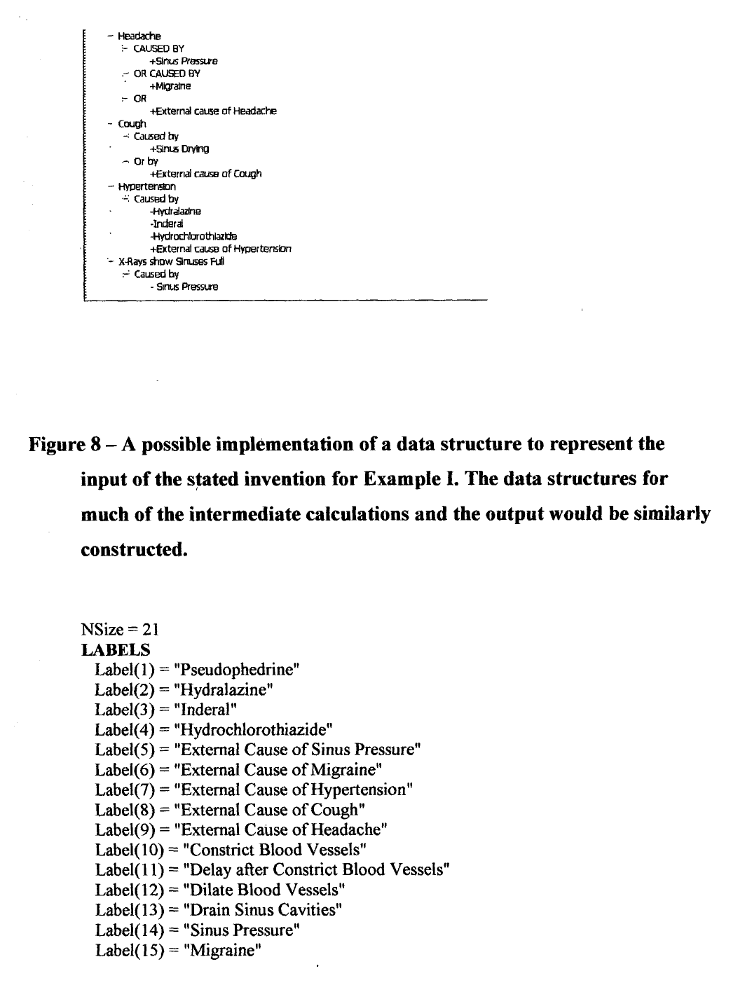

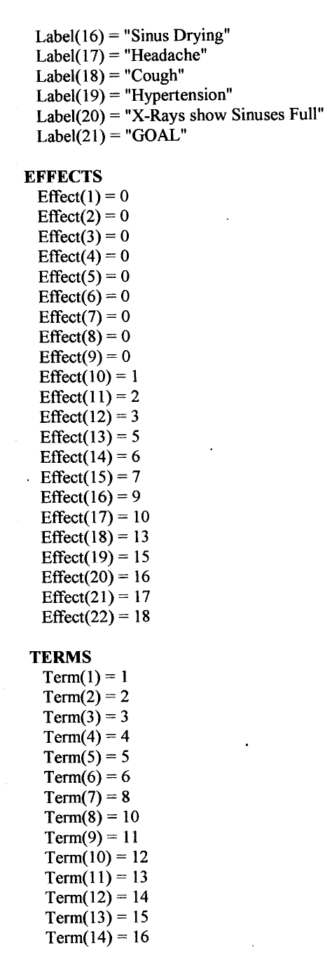

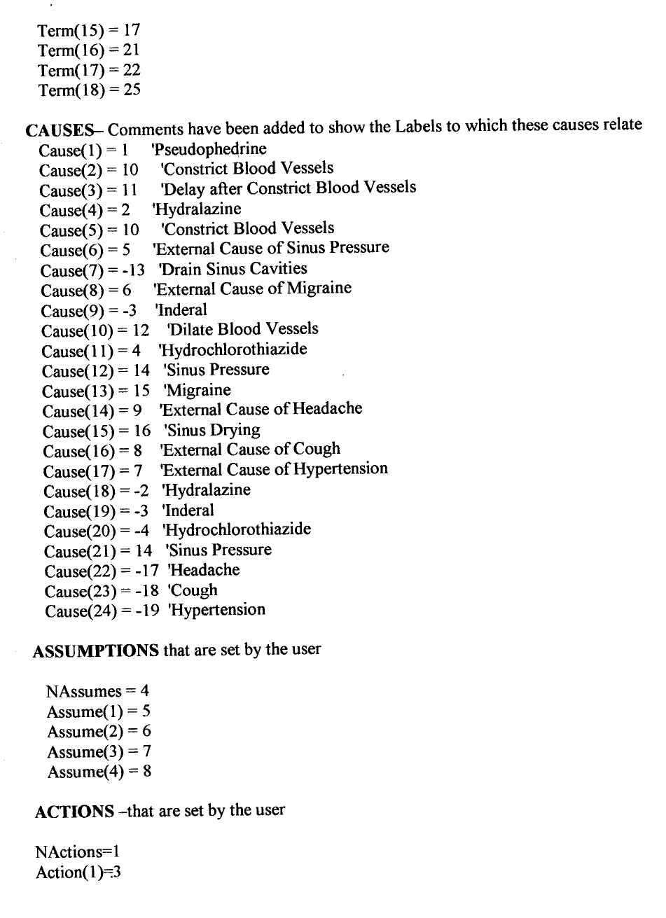

FIG. 6 illustrations the sequential generation and solution of the Boolean equations of FIG. 5 by application of the rules in FIG. 4. To the right of each application of a rule is shown the rule from FIG. 4 that is being applied to achieve that result.

In another embodiment the software can display the model in either of the representations of FIGS. 1, 2 or 3, as well as in a narrative form, as shown in FIG. 7 with respect to Example I.

Having in various embodiments constructed the model, we now turn to further embodiments of using the model. These include a forward mode and a backward mode. Either of these modes may be used for developing the model, or using/applying the model.

In the Forward mode one starts with a given Boolean expression for the truth or falsity of primary events, and then determines the truth or falsity of any or all of the secondary events in a sequential manner.

In contrast in the Backward mode one starts with given Boolean expressions for the truth or falsity of all secondary events, and then determines the truth or falsity of primary events that would produce the truth or non-truth of those secondary events.

The cause and effect model is represented by a system of simultaneous Boolean equations with the Boolean expressions stated in one implementation in canonical disjunctive form. The software solves these Boolean equations to express the existence or non-existence of every event in terms of the existence or non-existence of the primary events. From this one can obtain a Boolean expression for the primary causes of any event/effect considered in the system. Each term in this expression represents the result of a mechanism consisting of paths through the primitive cause and effect relations.

In conjunction with the backward mode that describes secondary events in terms of primary events, one can choose as an option a term/mechanism One can then ask for the Negation of this term. Having chosen a term from the computed consequences on secondary events in terms of primary events, one can ask for its negation. One can then ask for the consequences of applying these actions represented by any term in either the consequences or the negation of an effect as Controllables or Assumptions. Once seeing the consequences one may rule out that option as not appropriate.

Where it is impractical to experiment on a real system because of lack of access to the system or harm that may occur as a result of the experiments and/or where there does not already exist experience in the overall behavior of the system, one can by using the method of this patent build a cause and effect model from elementary/primitive cause and effect relations where these elementary/primitive cause and effect relations may be known where there is not available experience or knowledge of the overall behavior of the system that an established expert might have.

The Boolean equations may be used first to provide the cause and effect mechanisms as paths through the system of cause and effect relations, whereby other calculations, such as but not limited to probabilities or costs, can be performed on the events along these paths.

In the case of complex and automated manufacturing processes, or service systems, the diagnosis necessary for improvement of the process, say for example to improve efficiency or increase production yield, are preferably done using the hypothesis of the model before being performed on the system itself

Method of Solving Boolean Expressions

The model in FIG. 3a was initially stated in terms of events q, r, s, t, u, and v. The rows and their columns are reordered by the process of partitioning so that all the marks in the matrix are either below the diagonal or confined to the smallest possible square blocks on the diagonal to get FIG. 3b. The ordering as it would appear in the other matrix is shown to the right and below each matrix. This reordering by partitioning brings the primary events, those that depend on no other events but can be set by the user, to the top of the matrix. In FIG. 3b these primary events are designated as a and b.

The equations within each block on the diagonal are non-recursive, that is each equation depends directly or indirectly on all the other equations within the same block so that they cannot be solved in any simple forward sequence such that each independent variable is already known before it is used. Thus both forward substitution and reduction and backward substitution and reduction (FIG. 1b) are required to solve the equations within each block.

The equations are solved using the Boolean and meta rules in FIG. 4. A forward substitution is made followed by a backward substitution as necessary for non-recursive systems of equations so as to express all the secondary events in terms of the primary events.

FIG. 5 shows the Boolean equations corresponding to the matrix in FIG. 3b.

FIG. 6 shows the calculations carried out on the equations in FIG. 5 to reach the conclusion that:

c=a+b

d=T

e=T

f=a

The rules applied to achieve each equation of FIG. 6 are shown to the right of the equation.

The Boolean equations can be solved by forward substitution in the order they are presented in the partitioned matrix except that the equations within a block must be solved using both forward and backward substitution.

By partitioning the matrix as in FIG. 3b a distinction can be made between those equations that can be solved recursively, i.e., just by forward substitution and reduction, and those within blocks that must be solved non-recursively, i.e., by both forward and backward substitution and reduction. Equations that can be solved recursively depend only on causes that appear only in cells below and to the left of the diagonal demarcation, that is cells marked by X, whereas the non-recursive equations have one or more events as dependent variables where the independent variables appear in cells to the right and above the diagonal.

Thus, gathering the equations into non-recursive blocks and ordering the blocks in a recursive order is preferred as it confines all feedback cycles to within blocks to make it easier for the user to understand the feedback cycles.

In using the cause and effect model one solves the simultaneous system of Boolean equations by a forward process of substitution and reduction followed by a backward process of substitution and reduction. The calculation for the forward and backward processes are illustrated in FIG. 6 with respect to the matrix representation in FIG. 3a.

In implementing the embodiments of the invention via a software instruction code a method of substitution is used to express every secondary event in terms of the primary events.

a. The forward process of substitution and reduction consists of processing each equation in the partitioned order from the first to the last eliminating by substitution all dependencies shown below the diagonal of the matrix as represented in FIG. 3b., represented in FIG. 6 by the application of rules S1-2, D1-2 from FIG. 4.

b. The backward process of substitution and reduction consists of processing each equation from the last to the first in the order given by the process of partitioning eliminating by substitution all dependencies shown above the diagonal in FIG. 3b, using rules: S1-2, D1-2, R1-10 and E1-4 from FIG. 4.

During these processes Boolean rules are used to reduce Boolean expressions to the simplest form so as not to generate unnecessary operations, that is by first applying rules R1-5 in FIG. 4 as shown in the sequence of equations in FIG. 6. The result of these processes is that all secondary events are expressed as Boolean functions of the primary events.

### EXAMPLES

### Example I

The first example of an embodiment of the invention is the use of the invention to explain and diagnose the causes of observed human physiological conditions, to present means for causing or preventing those conditions, and determining the consequences of each of several means that might be selected as options so as to rule out mechanisms that do not conform to observation or rule out means that could result in undesirable or less desirable consequences or side effects.

The consequences of selecting various means can be determined from the model before they are prescribed to the patient, saving the patient from potentially harmful means.

This might be used by a physician diagnosing a patient's illness, or by a patient diagnosing his or her own illness.

As used by a person experienced in developing and modifying models, the model itself may be changed by the physician to accommodate new knowledge or knowledge specific to a particular patient or circumstance.

While the physician may be aware of medications that will usually successfully treat a condition, the inventive Cause and Effect model and methods can incorporate a vast and increasing pharmacological and physiological basis for treatment, such medical treatment including exercise, rest, physical therapy, radiation treatment, surgery, medical treatment, counseling, psychotherapy and the like.

While a person skilled in the subject and in developing cause and effect models with this invention might develop the basic model, it is readily updated by the same person or another person so skilled to accommodate new medications or more complete understanding of drug physiological responses or undesired drug interactions.

A clinician using a computer implementation of the cause and effect model program is presented with various output or queries, which are italicized for this example. Thus, the initial query might start with the patient complaint, and request:

Click on the observed effect to be prevented:

□ Headache

□ Cough

□ Hypertension

If the physician clicked on headache, the program would respond:

Do X-rays of the sinuses show that they are full? Yes □ No □

If the physician clicked on No, then the program would respond:

Apparently the headache is due to a migraine or other cause and not due to sinus pressure. Consider prescribing Inderal. Avoid taking Hydralazine.

The data structures and their use in the operation of the computer are best understood by first considering the creation of the model. The cause and effect model, as a non-limiting example, is entered as a series of expressions that define the primary and secondary events as shown in FIG. 2 or FIG. 3. Following the method of solving the resulting Boolean expressions each secondary event can be expressed as an effect caused by the existence of one or more secondary or primary events.

CONTROL Inderal

CONTROL Hydrochlorothiazide

ASSUME External Cause of Sinus Pressure

ASSUME External Cause of Migraine

ASSUME External Cause of Hypertension

ASSUME External Cause of Cough

ASSUME External Cause of Headache

EFFECT Constrict Blood Vessels

CAUSED BY Pseudophedrine

EFFECT Delay after Constrict Blood Vessels

CAUSED BY Constrict Blood Vessels

EFFECT Dilate Blood Vessels

CAUSED BY Delay after Constrict Blood Vessels

OR

CAUSED BY Hydralazine

EFFECT Drain Sinus Cavities

CAUSED BY Constrict Blood Vessels

EFFECT Sinus Pressure

CAUSED BY External Cause of Sinus Pressure

AND NOT Drain Sinus Cavities

EFFECT Migraine

CAUSED BY External Cause of Migraine

AND NOT Inderal

OR

CAUSED BY Dilate Blood Vessels

EFFECT Sinus Drying

CAUSED BY Hydrochlorothiazide

EFFECT Headache

CAUSED BY Sinus Pressure

OR

CAUSED BY Migraine

OR

CAUSED BY External Cause of Headache

EFFECT Cough

CAUSED BY Sinus Drying

OR

CAUSED BY External Cause of Cough

EFFECT Hypertension

CAUSED BY External Cause of Hypertension

AND NOT Hydralazine

AND NOT Inderal

AND NOT Hydrochlorothiazide

EFFECT X-Rays show Sinuses Full

CAUSED BY Sinus Pressure

EFFECT GOAL

CAUSED BY NOT Headache

AND NOT Cough

AND NOT Hypertension

Although all possible relationships are useful to the person building or verifying the model, the clinician is primarily interested in the subset useful in alleviating the patient's symptoms or conditions. Thus, only a subset of the above relationships may be presented based on the response to user interface prompt of the following list of observable events:

□ Headache

□ Cough

□ Hypertension

For example clicking on “Headache” would result in the following conclusion by the program:

EFFECT Headache IS

CAUSED BY External Cause of Migraine

AND NOT Inderal

OR

CAUSED BY External Cause of Sinus Pressure

AND NOT Pseudophedrine

OR

CAUSED BY Hydralazine

OR

CAUSED BY Pseudophedrine

EFFECT NOT Headache IS

CAUSED BY Inderal

AND NOT External Cause of Sinus Pressure

AND NOT Hydralazine

AND NOT Pseudophedrine

ASSUMING External Cause of Migraine

OR

CAUSED BY Pseudophedrine

AND NOT External Cause of Migraine

AND NOT Hydralazine

ASSUMING External Cause of Sinus Pressure

Selecting headache and choosing the operation Compute Negative of Current Effect would yield the following results:

EFFECT NOT Headache IS

CAUSED BY Inderal

AND NOT External cause of Sinus Pressure

AND NOT External cause of Headache

AND NOT Hydralazine

AND NOT Pseudophedrine

OR

CAUSED BY NOT External cause of Migraine

AND NOT External cause of Sinus Pressure

AND NOT External cause of Headache

AND NOT Hydralazine

AND NOT Pseudophedrine

There are two mechanisms represented by the two ‘CAUSED BY” terms that could prevent a headache. In either case one should not take Hydralazine. One mechanism would suggest taking Pseudophedrine assuming that there is an External Cause of Sinus Pressure. Then the program asks itself what would be the consequences of External Cause of Sinus Pressure to determine whether there might be other observable effects that can be used to rule in or rule out a headache. The software then checks the consequences of External Cause of Sinus Pressure and concludes.

1 ASSUME External Cause of Sinus Pressure

2 EFFECT Sinus Pressure

CAUSED BY External Cause of Sinus Pressure REF 1

3 EFFECT Headache

CAUSED BY Sinus Pressure REF 2

4 EFFECT X-Rays show Sinuses Full

CAUSED BY Sinus Pressure REF 2

So the program advises that X-rays should be taken to determine whether there exists an “External Cause of Sinus Pressure”. If the physician replies that X-rays show that the sinuses are not full, then this mechanism can be ruled out. Then the program suggests that the cause of the headache might be migraine or some other cause and proposes prescribing Inderal.

In order to instruct the clinician, or the user of a model template in the most productive method of resolving the problem, that is with the least number of tests or experiments or risks, the computer implementation of the query takes into account the characterization of secondary events as goals, observable, or detrimental effects. Thus by first asking the clinician to define the goals or objectives of a successful treatment or outcome the next queries are directed to observation or procedures necessary to diagnose the cause of the symptoms to be alleviated. Following the diagnosis via observable or determinable events the potential treatment are suggested in the order of those without detrimental side effects followed by those with potential side effects or other contra-indications.

In yet another embodiment of the invention additional information can be associated with each secondary event to aid in the suggestion of tests or actions. For example, the cost or time required for a diagnostic test, the cost associated with each treatment method, the probability or severity of negative side effects.

Once the mechanisms are determined, various calculations can be made on the events in these mechanisms using forms of mathematics other than Boolean.

An example would be to assign probabilities to primary events that are set and to each term such as to compute the probability of the occurrence of each event.

Although cause and effect is one of the principal methods used by humans for reasoning, novel methods of applying the principles to complex systems are enabled by the novel method and computer implementations disclosed herein.

Accordingly, non-limiting examples of alternative methods of use include the diagnosis of medical conditions as well as machine or systems failures, manufacturing problems, the analysis and interpretation of forensic or archeological evidence, failure mode analysis and prevention including non-recursive and recursive (tree shaped) systems.

### Example II

This is a small artificial example to demonstrate that the method applies were the system of Boolean equations is non-recursive, that is involving both feed forward and feedback. All the figures except 2a pertain to this example.

### Example III

Data Representation

FIG. 7 is a non-limiting example of a Data Representation for displaying the model of the inventive method illustrated in its application to Example I wherein the data representation corresponds to an outline. At the highest level of the outline is the model name, in this case “Headache”. Below the model name in the outline are the Events. Below an Event in the outline are the Terms which collect the causes that are ANDed together to satisfy the event. The terms are shown in this example as “Caused by”. Below a Term in the outline are the Causes. The Cause is specified as positive if the presence of a cause is required to satisfy the term, or negative if the absence of the cause is required to satisfy the term. If all the specified Causes are satisfied, the Term is satisfied. If any Term for an event is satisfied, that event is satisfied and thus considered to exist.

In the corresponding data structure there is a data field for the number of events (NEvents). Data fields (arrays) for Labels, Events, Terms and Causes each have ordered sub-data fields. The sub-data field of the Effect data field corresponding to Effect i is a pointer to the first sub-data field in the Term data field corresponding to the first Term for that Effect. The sub-data field of the Effect data field corresponding to Effect i+1 is a pointer to the first sub-data field in the Term data field corresponding to the first Term for Event i+1, so it points one past the last sub-data field of the Term data field corresponding the Event i. Each sub-data field of data field Term points to a sub-data field Cause that corresponds to a cause event that appears in that Term. Each sub-data field of the data field Cause points to event that represents a cause. The last sub-data field of the Effect data field points to one past the end of the last sub-data field of the Terms data field and the last sub-data field of the Terms data field points to one past the end of the last sub-data field of the Causes data field. In addition each sub-data field representing a cause in the third data field can be labeled, in one implementation by plus or minus, as to whether its existence or non-existence is required to satisfy the term.

In another method of using the invention one can use a graphical user interface to point to and click on any term of a secondary effect that has been expressed in terms of the primary events and view any or all of the consequences of setting the primary events as specified in this term.

Alternatively, one can use a graphical user interface to point and click on any term of the negation of a secondary effect that has been expressed in terms of the primary events and view any or all of the consequences of setting the primary events as specified in this term.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. A method of developing a cause and effect model, the method comprising the steps of:
a) specifying primary events,
b) characterizing each primary event as either a controllable or an assumption,
c) specifying secondary events,
d) providing a plurality of primitive cause and effect relation between at least a subset of the events,
e) representing the plurality of primitive cause and effect relations by a system of simultaneous Boolean equations having Boolean expressions stated in one implementation in canonical disjunctive form,
f) solving the Boolean equations to express the existence or non-existence of every secondary event in terms of the existence or non-existence of the primary events.

2. A method of developing a cause and effect model according to claim 1, the method further comprising the steps of:
a) characterizing each secondary event as observable, or intermediate.
b) providing the state of one or more observable secondary events.

3. A method of developing a cause and effect model according to claim 1, the method further comprising the steps of:
a) assigning a first set of probabilities to each of the primary effects, and
b) assigning to each term of each primitive cause and effect relation a second set of probabilities that the joint presence or absence of the causes specified by that term would cause the resulting event to exist,
c) multiplying the probabilities of the first and second sets of probability associated with each cause of each term to reach a third set of probabilities of all the causes for that term existing or not existing as specified by the term, and thus the term being satisfied.

4. A method of using a cause and effect model wherein a plurality of primitive cause and effect relations between primary and secondary events are represented by a system of simultaneous Boolean equations, the method comprising:
a) selecting one or more secondary events as a goal,
b) solving least a subset of one or more Boolean equations to state the secondary events in terms of primary events,
c) providing the status of existence of one or more secondary events.

5. A method of using a cause and effect model according to claim 4, the method further comprising providing via a graphic user interface:
a) a solution to at least a subset of one or more Boolean equations to state the secondary events in terms of primary events.

6. A method of using a cause and effect model according to claim 4, the method further comprising providing via a graphic user interface:
a) a solution to at least a subset of one or more Boolean equations to state the secondary events in terms of primary events that do not have a detrimental effect on one or more of the goals.

7. A method of using a cause and effect model according to claim 4, the method further comprising providing via a graphic user interface:
a) a solution to at least a subset of one or more Boolean equations to state the secondary events in terms of primary events that may have detrimental results in associated with one or more of the goals.

8. A method of using a cause and effect model according to claim 4, the method further comprising
a) providing via a graphic user interface one or more Boolean equations to state the detrimental results associated with each of the goals.

9. A method of using a cause and effect model according to claim 4, the method further comprising providing the status of at least one secondary event.

10. A computer-readable medium having stored thereon a data structure comprising:
a) a first data field containing data representing events,
b) A second data field containing data representing terms,
c) A third data field containing data representing causes,
d) A first sub-data field of the first data field containing pointers to the first of a sequential subset of sub-data fields of the second data field,
e) A first sub-data field of the second data field containing pointers to the first of a sequential subset of sub-data fields of the third data field corresponding to a term, which in turn points to the first of a sequential subset of sub-data fields corresponding to the term,
f) A last pointer added to the end of the first sub-data field of the second data field that points to one position past the end of the first sub-data field of the third data field,
g) A last pointer added to the end of the first sub-data field of the first data field that points to the last pointer that was added to the end of the first sub-data field of the second data field,
h) a second sub-data field of the first data field containing data representing various information about the events such as but not limited to whether the events are primary, secondary, intermediate or observable,
i) a third sub-data field of the first data field representing the relationship between each event and one or more of the other events,
j) a third sub-data field of the first data field for characterizing the reordering of the events by the partitioning process,

11. A computer-readable medium having stored thereon a data structure according to claim 10 further comprising another sub-data field for charactering one or more of the secondary events by a status selected from the group consisting of non-detrimental and detrimental.

12. A computer-readable medium having stored thereon a data structure according to claim 10, further comprising another sub-data field for charactering one or more of the secondary events by a characteristic of the event for use in a numerical calculation.

13. A set of application program interfaces embodied on a computer readable medium for execution on a computer in conjunction with an application program that develops a cause and effect model, the interfaces comprising:
a) a first interface that receives one or more primary events;
b) a second interface that the prompts for the characterization of each primary as either a controllable or assumption;
c) a third interface that receives secondary events;
d) a fourth interface that prompts for the characterization of the causal relationship of each primary event to any other secondary event;
e) a fifth interface that prompts for the characterization of the causal relationship of each secondary event to any other secondary event,
f) a sixth interface that receives at least one instruction characterizing one or more secondary events as a goal.

14. A set of application program interfaces embodied on a computer readable medium according to claim 13, further comprising another interface that:
a) prompts for the characterization of each secondary event as observable or determinable.

15. A set of application program interfaces according to claim 13, further comprising another interface that prompts for the characterization of each secondary event as detrimental or not detrimental.

16. A set of application program interfaces according to claim 13, further comprising another interface that prompts for the characterization of each secondary event by a characteristic of the event for use in a numerical calculation.

17. A set of application program interfaces according to claim 15, further comprising another interface that prompts for the characterization of each secondary event by a warning notice of a detrimental character.

18. A set of application program interfaces according to claim 13, further comprising another interface that prompts for the characterization of a probability function associated with each causal relationship prompted for in the fifth interface.

19. A set of application program interfaces according to claim 13, further comprising another interface that prompts for the characterization of a probability function associated with each primary event prompted for in the first interface.

20. A method according to claim 4 wherein one or more of the primary events represents a drug or medication treatment protocol and one or more of the secondary events represents a patient symptom or outcome of treatment.

21. A method according to claim 4 wherein one or more of the primary events represents a drug or medication treatment protocol and one or more of the secondary events represents an organ or tissue response.

22. A method according to claim 20 wherein at least one of the primary events has a cost associated with the treatment protocol and the method further provides output to user of the cost associated with each of the treatments.

23. A method according to claim 20 wherein at least one of the secondary events has a cost associated with the patient symptom or outcome of treatment and the method further provides output to user of the cost associated with each of the treatments.

24. A method according to claim 20 wherein at least one of the patient symptoms or outcomes of treatment has an associated probability of occurrence.

25. A method according to claim 4 wherein one or more of the primary events represents a drug or medication treatment protocol and one or more of the secondary events represents a patient symptom or outcome of treatment and at least one of the patient symptoms or outcomes of treatment has an associated probability of occurrence, and at least one of the primary events has a cost associated with the treatment protocol and the method further comprises computing the value of a treatment based on the probability of each outcome or symptom and the product of the associated cost.

26. A method of using a cause and effect model according to claim 4 wherein said method is implemented by providing a computer readable medium having computer executable instructions.

27. A method of using a cause and effect model according to claim 4, the method further comprising:
a) solving said system of Boolean equations to represent all effects/events contained in said system as functions of a subset of predetermined primary causes to aid a user in diagnosing the primary causes of certain effects.

28. A method of using a cause and effect model according to claim 27, wherein:
a) at least one subset of primary causes are set by the user to be true, and
b) the method further comprising determining all effects and events that are consequents of said subset of primary causes.

29. A computer readable medium having stored thereon software in the form of computer executable instructions, the instructions comprising:
a) a cause and effect model comprising a system of a plurality of simultaneous Boolean equations representing a plurality of primitive cause and effect relations between primary events and secondary events,
b) means for selecting a combinations of primary causes,
c) means to determine the consequent effects of a specified combination of primary causes on all secondary events.

30. A computer readable medium having stored thereon software in the form of computer executable instructions according to 29, wherein the means to determine the consequent effects of all primary causes comprises;
a) means for tracing all the cause and effect paths through said cause and effect model between the said primary causes and at least a selected subset of consequent effects.

31. A set of application program interfaces embodied on a computer readable medium for execution on a computer in conjunction with an application program that develops a cause and effect model, the interfaces comprising
a) a representation of the model using an outline to show:
i) a first level to display Effects,
ii) second level below the first level to display Terms,
iii) a third a level below the second level to display Causes.

32. A set of application program interfaces embodied on a computer readable medium for execution on a computer in conjunction with an application program that develops a cause and effect model, the interfaces comprising:
a) means for inputting primitive cause and effect relations represented by a plurality of Boolean equations each composed of Boolean and's and or's to create a proposed cause and effect model.

33. A set of application program interfaces according to claim 32, the interfaces further comprising:
a) means of inputting a subset of primary causes set to true/exist to determine all effects consequent to said subset of primary causes.

34. A set of application program interfaces according to claim 32, the interfaces further comprising:
a) means of selecting from a plurality of alternative sets of primary causes of an event only those sets of primary causes that have sufficient value to justify any undesired consequences.

35. A set of application program interfaces according to claim 32, the interfaces further comprising:
a) means to input new primitive cause and effect relations or modify previously specified primitive cause and effect relations.

36. Software fixed on computer readable medium to provide computer executable instructions, the software comprising:
a) means to develop cause and effect hypotheses,
b) means to determine the effects/consequences of these hypotheses,
c) means to compare the fit of the effects/consequences to reality,
d) means to trace the mechanism that produces consequences that do not fit reality,
e) means to change the hypotheses.

37. Software fixed on computer readable medium to provide computer executable instructions, the software comprising:
a) means to develop cause and effect hypotheses for determining the likelihood of a target event as a plurality of terms representing causal relationships between primary and secondary events,
b) means to assign probabilities to each term relating the satisfaction of that term to the existence of a target event,
c) means to assign probabilities to each of the primary events set to exist so the probability of the existence of each event can be computed.

38. A method of developing a model according to claim 1, the method further comprising the step of transmitting from a first computer system to a second computer system one or more instruction that modify at least one of the simultaneous Boolean equations.

39. A method of using a cause and effect model according to claim 4, the method further comprising the steps of:
a) receiving from a first computer system one or more instruction that modify at least one of the simultaneous Boolean equations associated with the memory system of second computer system,
b) solving via the second computer system at least a subset of one or more Boolean equations to state the secondary events in terms of primary events.
